(19) United States
(12) Patent Application Publication
(10) Pub. No.: US 2009/0213270 A1
(43) Pub. Date: Aug. 27, 2009

(54) VIDEO INDEXING AND FINGERPRINTING FOR VIDEO ENHANCEMENT

(76) Inventors: Ryan Ismert, San Francisco, CA (US); Marvin S. White, San Carlos, CA (US)

Correspondence Address: Vierra Magen Marcus & DeNiro LLP, 575 Market Street, Suite 2500, San Francisco, CA, 94105, US

(21) Appl. No.: 12/035,562

(22) Filed: Feb. 22, 2008

(51) Int. Cl. F26B 13/10

(52) U.S. Cl. 348/575

(57) ABSTRACT

Metadata associated with a video is used to enhance a display of the video. A fingerprint is calculated using a particular fingerprint algorithm for one or more frames or images of the video. The fingerprint is associated with metadata for the one or more frames or images, and the fingerprint and the associated metadata are stored in a metadata repository. When a user requests enhancement of a video at a client device, the client device will calculate a fingerprint for one or more frames or images of the video to be enhanced using the same fingerprint algorithm and use the calculated fingerprint to access metadata associated with that fingerprint in the metadata repository. The accessed metadata is used to enhance a display of the video based on the user request.

### BACKGROUND OF THE INVENTION

Many applications for augmenting, repurposing, or enhancing video require determining some set of metadata for the video. The metadata may be relevant to a segment of video as short as a single frame or image, or as long as the entire program. For example, metadata may include information about a scene or event captured in the video, data associated with camera position for that segment of video, copyright information, etc.

Although many video formats allow a limited amount of metadata to be stored directly in the video, the volume of metadata needed for enhancement often precludes use of this mechanism. Additionally, in-video metadata has limited survivability as the video goes through various video processing techniques. Therefore, metadata is typically stored separately from the video itself.

One technique for accessing metadata stored separately from the video itself involves the use of a timestamp. When video enhancement is done at or near the point where the video is captured, both the metadata and the video may be timestamped. The timestamp may be inserted into the video using a standard timecode format, such as VITC or RP-188. Additionally, it is possible to enhance the video at any desired time using a known offset between the time of arrival of the video and the relevant data. However, when the metadata must be accessed at a distance from where the video is captured, the offset may not be known, and thus the metadata access may not be accurate. Additionally, the timestamp suffers from the same survivability problems described above, for general metadata.

In order to successfully enhance video using metadata, without restrictions on the time and place of the lookup, the metadata must be associated with the video in a frame-accurate or image-accurate manner.

### SUMMARY OF THE INVENTION

The technology described herein provides a technique for enhancing video using metadata, without restrictions on the time and place the metadata is accessed. One embodiment includes receiving video at a client device and calculating a first identifier of one or more frames of the video at the client device using particular features within the one or more frames. The client device accesses metadata associated with the one or more frames using the first identifier and enhances the one or more frames using the metadata.

One embodiment includes upstream inspection circuitry, association circuitry, downstream inspection circuitry, and enhancement circuitry. The upstream inspection circuitry receives video and calculates an identifier of one or more frames of the video using particular features within the one or more frames. The association circuitry associates the identifier with metadata of the one or more frames. The downstream inspection circuitry receives the video, calculates the identifier of the one or more frames using the same particular features, and accesses the metadata using the identifier.

One embodiment includes video input circuitry, downstream inspection circuitry, and enhancement circuitry. The input circuitry receives video. The downstream inspection circuitry calculates an identifier of one or more frames of the video using particular features within the one or more frames and accesses metadata associated with the one or more frames using the identifier. The enhancement circuitry enhances the one or more frames using the accessed metadata.

One embodiment includes a first set of one or more processors, a second set of one or more processors in communication with the first set of one or more processors, and a client device. The first set of one or more processors receives video and calculates an identifier of one or more frames of the video using particular features within the one or more frames. The second set of one or more processors associates the identifier with metadata of the one or more frames. The client device receives the video, calculates the identifier using the same particular features within the one or more frames of video, accesses the metadata using the calculated identifier, and enhances the one or more frames using the accessed metadata.

### BRIEF DESCRIPTION OF THE DRAWINGS

FIG. 1 depicts a block diagram of one example of a system for enhancing video.

FIG. 2 depicts a block diagram of one example of a broadcast unit.

FIG. 3 depicts a block diagram of one example of an upstream inspector.

FIG. 4 depicts a block diagram of one example of a metadata capture module.

FIG. 5 depicts a block diagram of one example of a client device.

FIG. 6 is a flow chart of one example of a process for enhancing video.

FIG. 7 is a flow chart of one example of a process for calculating a fingerprint for video.

FIG. 8 depicts one example of features used to calculate a fingerprint for video.

FIG. 9 is a flow chart of one example of a process for capturing metadata associated with video.

FIG. 10 is a flow chart of one example of a process for associating metadata with a fingerprint.

FIG. 11 depicts one example of how metadata is indexed by an associated fingerprint in the metadata repository.

FIG. 12A is a flow chart of one example of a process for enhancing video based on a request from a user.

FIG. 12B is a flow chart of another example of a process for enhancing video based on a request from a user.

FIG. 13A depicts one example of a video frame or image before enhancing.

FIG. 13B depicts one example of a video frame or image after enhancing.

### DETAILED DESCRIPTION

The disclosed technology provides a system and method for enhancing video at a client device. A fingerprint for one or more frames or images of video is calculated using a fingerprint algorithm, and the fingerprint is associated with metadata for those one or more frames or images of video. The metadata and the associated fingerprint are stored in a metadata repository. When a user of the client device requests that a video be enhanced in a particular way, the client device calculates a fingerprint for one or more images of the video using a fingerprint algorithm that yields the same results and accesses the metadata associated with the calculated fingerprint from the metadata repository. The accessed metadata is used to enhance the one or more frames or images of video in the particular way requested by the user. The client device may continue to calculate fingerprints for video as the video is received and access metadata associated with those fingerprints for continued enhancement of the video. In an alternate embodiment, the client device has the ability to count frames or images of video. In this embodiment, the client device may calculate a fingerprint for the first frame or image or the first few frames or images of the video received at the client device, retrieve the metadata associated with the fingerprint, and perform subsequent metadata lookups using a frame or image count relative to the frame or image corresponding to the calculated fingerprint. In another embodiment, the client device may perform subsequent metadata lookups using a time relative to the frame or image corresponding to the fingerprint.

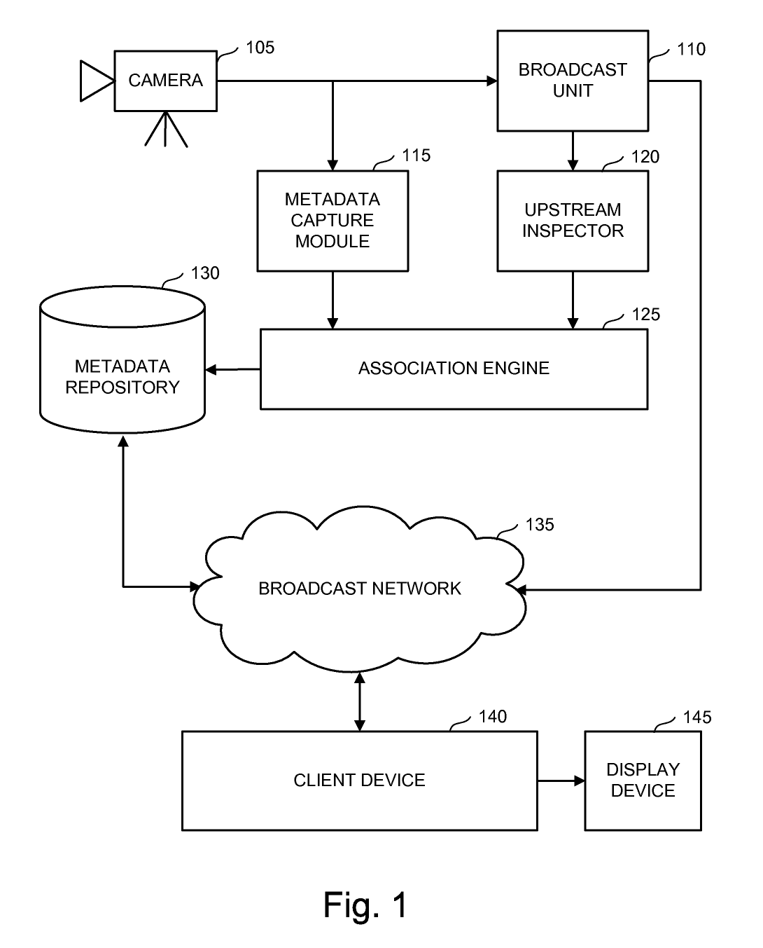

FIG. 1 shows one example of a system for enhancing video. The system includes a camera 105, a broadcast unit 110, a metadata capture module 115, an upstream inspector 120, an association engine 125, and a metadata repository 130. The camera 105 captures video, and the video is sent to the broadcast unit 110 and the metadata capture module 115. The metadata capture module 115 captures metadata from the camera 105, such as camera position, for example. The metadata capture module 115 also captures metadata associated with the events or scenes within the video, such as the score for a game or the location of the people within the video, for example. The broadcast unit 110 sends the video from the camera to both the upstream inspector 120 and the client device 140. The upstream inspector 120 is used to calculate fingerprints for segments of video received. These segments of video can be as short as one frame or image or they can be several frames or images. For simplicity, a segment of video will be used to describe what is required for calculating a fingerprint. However, it should be noted that a segment of video may be one or more frames or images of video. Once a fingerprint has been calculated and the metadata has been captured, the association engine 125 receives the calculated fingerprint from the upstream inspector 120 and metadata captured at the metadata capture module 115 and associates the received fingerprints with their corresponding metadata. The metadata and the associated fingerprints are then stored in the metadata repository 130. In one embodiment, the camera 105, broadcast unit 110, metadata capture module 115, upstream inspector 120, association engine 125, and metadata repository 130 are components used and operated by a broadcast provider. A broadcast provider can be any provider of video service to clients or users, such as a user of client device 140.

FIG. 1 also includes a broadcast network 135, a client device 140, and a display device 145. The client device 140 receives video from the broadcast unit 110 via the broadcast network 135 and sends the video to the display device 145 to be displayed for the user. When the user inputs a request for video enhancement at the client device 140, the client device will calculate a fingerprint for the received video. The client device 140 will then use the calculated fingerprint to look up the associated metadata in the metadata repository 130 via the broadcast network 135. The client device 140 will use the accessed metadata to enhance the video according to the request from the user. The enhanced video will then be displayed on the display device 145. The display device 145 can be any output device capable of displaying video, such as a television, a computer monitor, etc.

The camera 105 can be any camera used to capture video, such as any analog or digital video camera. In one embodiment, the camera 105 is capable of accurately obtaining metadata associated with camera position, orientation, and intrinsic parameters of the video, such as data about camera pan, tilt, and zoom (PTZ) as the video is being recorded. The camera 105 can obtain such metadata with frame (analog video) or image (digital video) accuracy.

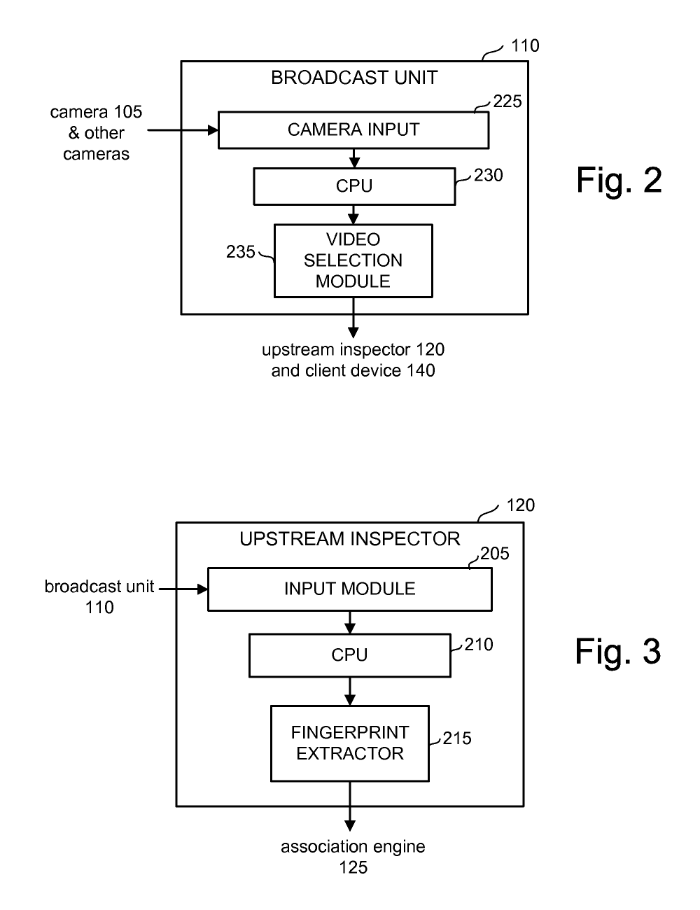

The broadcast unit 110 receives video from camera 105 and may also receive video from other cameras as well. The broadcast unit 110 is the module that broadcasts video to the client device 140 and to other client devices capable of receiving the video broadcast over the broadcast network 135. For example, the broadcast unit 110 may broadcast video to multiple users that subscribe to a broadcast provider. The broadcast unit 110 receives video from one or more cameras and sends the video to the users' client devices. For video received from more than one camera, the broadcast unit 110 may send video from one of the cameras depending on which video from which camera should be broadcast to the client device 140. However, the broadcast unit 110 may send all received video from one or more cameras to the upstream inspector 120 for fingerprint extraction. More detail about the broadcast unit 110 is described below in FIG. 2.

The upstream inspector 120 receives video from the broadcast unit 110 and calculates fingerprints for the video as it is received. A fingerprint is a unique identifier for a segment of a video generated using a fingerprint algorithm. The fingerprint algorithm can be any number of common image or video fingerprinting algorithms. The fingerprinting algorithm may work on individual frames or images or short segments of video. The fingerprinting algorithm allows the upstream inspector 120 to extract data about particular features in the segment of video and calculate a unique identifier using the extracted data in the calculation. For example, the extracted data can be color or intensity data for particular pixels in the segment of video or motion changes within a segment of video. The upstream inspector 120 calculates fingerprints for video received from the broadcast unit 110 and sends the fingerprints to the association engine 125. More detail about the upstream inspector is described below in FIG. 3.

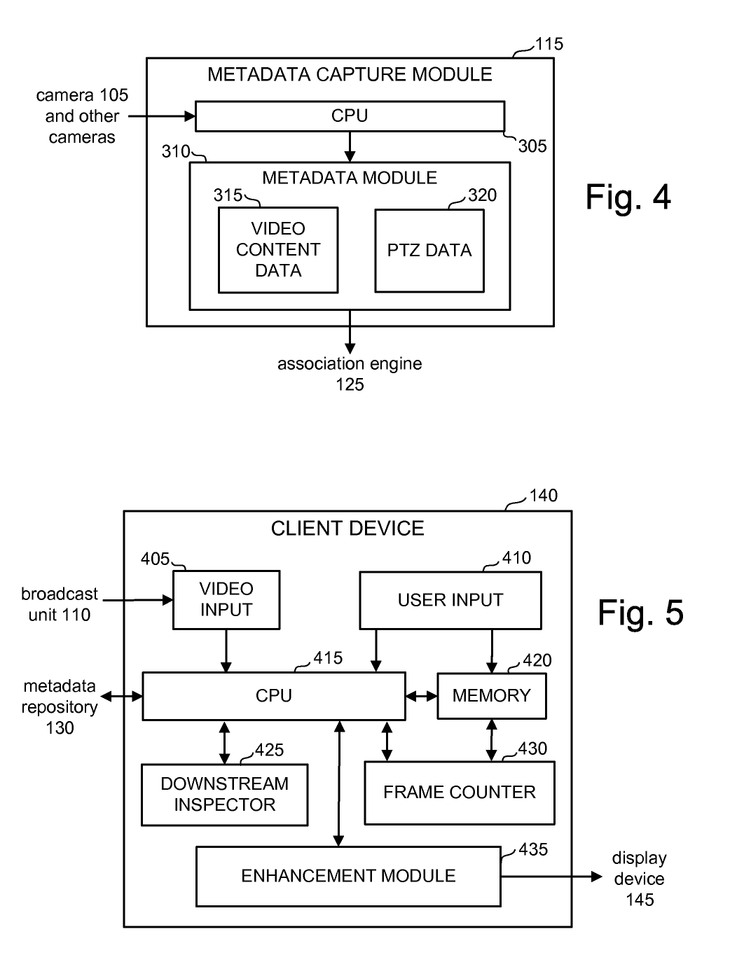

The metadata capture module 115 captures metadata associated with video received at the broadcast unit 110. The metadata can include any type of data associated with a segment of video. For example, if the segment of video was a sporting event, the metadata could include information about the event or scene occurring in the segment of video (e.g. a score for a game), information about the people in the segment of video (e.g. names, player statistics, location on the field), conditions surrounding the video capture (e.g. the field of view of the camera, where the camera was pointing, etc.), copyright information for the video, etc. The metadata capture module 115 sends the captured metadata to the association engine 125. More detail about the metadata capture module is described below in FIG. 4.

The association engine 125 associates the fingerprints received from the upstream inspector 120 with the corresponding metadata received from the metadata capture module 115. The association engine 125 should be located close enough to the point of video capture and metadata capture so as to accurately associate the fingerprints with the corresponding metadata. After forming the association between the fingerprint and the metadata, the association engine 125 sends the fingerprint and the associated metadata to the metadata repository 130.

The metadata repository 130 can be any type of memory storage unit. The metadata repository 130 stores the metadata for video and the associated fingerprint. The metadata repository 130 may support metadata lookup using any type of indexing parameters. In one embodiment, the metadata in the metadata repository 130 is indexed by its associated fingerprint. In another embodiment, the metadata is indexed in consecutive order of frames or images. In yet another embodiment, the metadata is indexed by time. However, the metadata and the associated fingerprint can be stored in any manner in the metadata repository 130. An example of how metadata may be stored in the metadata repository 130 is described below in FIG. 11.

The broadcast network 135 is the transmission medium between a client device and a broadcast provider. Video is received at the client device 140 via the broadcast network 135. Also, metadata can be retrieved by the client device 140 from the metadata repository 130 via the broadcast network 135.

The client device 140 is a user component that receives video for the user based on the user's request. For example, the user may use the client device 140 to input a channel that the user would like to view on the display device 145. Additionally, the user may use the client device 140 to input requests, such as a request to enhance video, for example. The client device 140 will perform the user request, such as changing the channel or enhancing a display of the video, and send the video to the display device 145 based on the request. The functions performed by the client device 140 can be implemented on any type of platform. For example, the client device 140 could be a set-top box, a computer, a mobile phone, etc.

Enhancement of a video through the client device 140 may be any change to a display of a video, such as a graphical insertion or image augmentation, for example. Continuing with the example of a sporting event, a display of a video can be enhanced to show a score for a game or if the position of a football is known for a frame or image of the video, the football can be enhanced to better display the football. For example, a graphic can be inserted where the football is located in the display of the frame or image of video to enhance the display of the football.

When video received at the client device 140 should be enhanced, the client device 140 will calculate a fingerprint for a segment of video received using a fingerprint algorithm which yields the same or similar enough results as the algorithm used in the upstream inspector 120. The fingerprint algorithm used in the client device 140 should be one that produces a fingerprint at least similar enough to that used in the upstream inspector 120 to produce a good match to the fingerprint calculated by the upstream inspector 120. In one embodiment, the fingerprint algorithm used at the client device 140 is a less computationally intensive variant of the algorithm used in the upstream inspector 120. The client device 140 will use the calculated fingerprint to look up the metadata associated with the fingerprint in the metadata repository 130 via the broadcast network 135. The metadata accessed from the metadata repository 130 is then used to enhance the segment of video. For example, if the user requested that the score be displayed, the metadata indicating the score for the segment of video will be used to graphically insert a display of a score onto the display of the video. The enhanced video would then be sent to the display device 145.

In one embodiment, the client device 140 will continuously calculate fingerprints and perform metadata lookups using the calculated fingerprints for the duration in which the video should be enhanced. In another embodiment, the client device 140 may calculate a fingerprint for a segment of video received at the client device 140. In this embodiment, the client device 140 has the ability to count frames or images of video received after the segment of video used to calculate the fingerprint. When metadata must be accessed, the client device 140 can use the count of frames or images relative to the fingerprint for the segment of video to look up the associated metadata in the metadata repository 130.

Some fingerprinting algorithms may generate a fingerprint that differs slightly from the fingerprint calculated in the upstream inspector 120. This may be due to the particularity of the fingerprinting algorithm used. For example, a fingerprinting algorithm may use very specific data within a segment of video. At or near the source of video capture, like at the upstream inspector 120 for example, a fingerprint may be calculated using the very specific data extracted from the segment. However, when video is broadcast to a client device 140 over a broadcast network 135, some of the data may have shifted or may even have been lost. Additionally, data may differ in cases where the video has been augmented before it is received at the client device 140, such as when a video segment has been cropped or distorted, for example. In those cases, the client device 140 may calculate fingerprints for several segments of video until a sequence of fingerprints can yield an accurate identity of frames or images. The client device 140 will search the metadata repository 130 to try to determine the identity of the frames or images received using the calculated fingerprints. Once the client device 140 has determined the identity of the frames or images, the associated metadata can be accurately accessed and used to enhance the video. More detail about the client device 140 is described in FIG. 5.

FIG. 2 is one example of the broadcast unit 110. The broadcast unit 110 includes camera input 225, CPU 230, and a video selection module 235. The camera input 225 receives video from camera 105 and may receive video from other cameras as well. The video is sent to the video selection module 235, where the video from one or more cameras may be selected for broadcast to the client device 140 using the CPU 230. The video selection module 235 also sends the video received from the camera input 225 to the upstream inspector 120.

An operator of the broadcast unit 110 may select which video from one or more cameras should be broadcast to the client device 140 and any other client devices capable of receiving the video (e.g. client devices that subscribe to the broadcast provider). The video selection module 235 programs the CPU 230 to broadcast the video to the client device 140 based on the operator's preference. For example, if two cameras capture video of an event from two different angles, an operator of the broadcast unit 110 may use one of the videos for a duration of time and subsequently decide to switch to the other angle captured by the second camera. The video selection module 235 is the module that facilitates the switching of video for broadcast to the client device 140 based on the operator's preference.

The video selection module 235 of the broadcast unit 110 also programs the CPU 230 to send any video received at the camera input 225 to the upstream inspector 120 to ensure that the upstream inspector 120 calculates fingerprints for all video captured at camera 105 and any other cameras.

FIG. 3 shows one example of the upstream inspector 120. The upstream inspector 120 includes input module 205, CPU 210, and fingerprint extractor 215. The input module 205 receives video from the broadcast unit 110. The fingerprint extractor 215 programs the CPU 210 to calculate fingerprints for the received video using a fingerprint algorithm. The fingerprint extractor 215 then sends the calculated fingerprint to the association engine 125.

The fingerprint extractor 215 programs the CPU 210 using a fingerprint algorithm. The fingerprint algorithm can be any common image or video fingerprinting algorithm. The fingerprint extractor 215 calculates fingerprints for segments of received video and sends the calculated fingerprint to the association engine 125. The fingerprint extractor 215 identifies particular features within the segment of video received. The particular features can include any features within the segment of video. For example, the particular features can be specific pixels or sets of pixels at certain locations within the segment of video. The particular features chosen are dependant on the fingerprint algorithm used. Once those particular features are located, the fingerprint extractor 215 extracts data from those particular features, such as data about color, intensity, or motion changes, for example. The fingerprint algorithm 215 then calculates an identifier or fingerprint that is unique to the segment of video using the extracted data. The fingerprint may be calculated using any of a number of functions for calculating fingerprints. Once the fingerprint is calculated, the fingerprint extractor 215 sends the fingerprint to the association engine 125.

FIG. 4 shows one example of the metadata capture module 115. The metadata capture module includes CPU 305 and metadata module 310. Metadata module 310 includes video content data 315 and PTZ data 320. The metadata module 310 programs CPU 305 to capture metadata associated with video from camera 105 and any other cameras using PTZ data 320. The metadata module 310 also programs CPU 305 to capture any other metadata associated with the content of the video received using video content data 315.

PTZ data 320 may capture the pan, tilt, and zoom (PTZ) metadata for segments of video. Video content data 315 may capture any metadata associated with a segment of video, such as data about events occurring in the segment of video, for example. As described in an earlier example, this data could be a score, player information, etc. The metadata module 310 will capture any metadata for the segment of video and sent the metadata to the association engine 125.

FIG. 5 shows one example of a client device 140. Client device 140 includes video input 405, user input 410, CPU 415, memory 420, downstream inspector 425, frame counter 430, and enhancement module 435. The video input 405 receives video from the broadcast unit 110 via the broadcast network 135. The user input 410 may receive a request from a user either manually or from a remote, such as a request to change the channel, for example. If a user inputs a request for video enhancement at the user input 410, the video that is received will be enhanced based on the user's request. The downstream inspector 425 will program CPU 415 to calculate a fingerprint for a segment of video received, look up metadata in the metadata repository 130 using the calculated fingerprint, and send the metadata to the enhancement module 435. The metadata enhancement module 435 will enhance the segment of video using the metadata received based on the user's request and send the enhanced video to the display device 145. Memory 420 can be any type of memory and is used to store any user preferences which the user indicates through the user input 410, such as enhancement preferences, for example. The enhancement module 435 may access memory 420 to enhance video based on any saved user preferences.

The downstream inspector 425 is similar to the upstream inspector 120 shown in FIG. 3. The downstream inspector 425 programs CPU 415 using a fingerprinting algorithm similar to that used in the upstream inspector 120. The downstream inspector 425 identifies the same or similar particular features within the segment of video, extracts data associated with those particular features, and applies the fingerprint algorithm to calculate a fingerprint for the segment of video. As previously discussed, the fingerprint algorithm used by the downstream inspector 425 should be one that produces a fingerprint similar enough to that produced by the upstream inspector 120. The downstream inspector 425 then uses the calculated fingerprint to access the corresponding metadata in the metadata repository 130.

In one embodiment, the downstream inspector 425 may calculate a fingerprint for one segment of video and perform a metadata lookup using the calculated fingerprint. The frame counter 430 will begin counting frames using the frame counter 430 for any segments of video received after the segment for which the fingerprint was calculated. For digital video, the frame counter 430 can also count images for any segments of video received after the segment for which the fingerprint was calculated. After the downstream inspector looks up the metadata for the segment of video for which the fingerprint was calculated, the downstream inspector 425 can then access metadata using a count of frames or images for the segments of video subsequently received. In this embodiment, the downstream inspector 425 will only have to calculate one fingerprint. The accessed metadata will be sent to the enhancement module 435 for enhancement. The enhanced video is then sent from the enhancement module 435 to the display device 145.

As previously discussed, a fingerprint calculated for a segment of video at the downstream inspector 425 may differ slightly from a fingerprint calculated for the same segment of video at the upstream inspector 120. In one embodiment, the downstream inspector 425 can continuously calculate fingerprints for segments of video received. The downstream inspector 425 will use a set of calculated fingerprints for consecutive segments of video to identify the corresponding metadata in the metadata repository 130. For example, if the metadata repository 130 indexes metadata by frame or image count, the downstream inspector 425 can match the set of calculated fingerprints to the list of fingerprints to determine which metadata is associated with the set of fingerprints.

The enhancement module 435 receives video from the video input 405 and corresponding metadata from the downstream inspector. If the video should not be enhanced, the enhancement module 435 will send the video to the display device 145 without enhancement. If a user indicates that the video should be enhanced (via the user input 410 or preferences stored in memory 420), the enhancement module 435 uses the metadata to enhance a display of the video based on the user's enhancement preferences before it is sent to the display device 145. The enhancement can be any change to the display of the video, including a graphical insertion, augmentation, etc. The enhancement module 435 may use any techniques for enhancing video. Once the video is enhanced, the enhancement module 435 will send the enhance video to the display device 145 for presentation to the user.

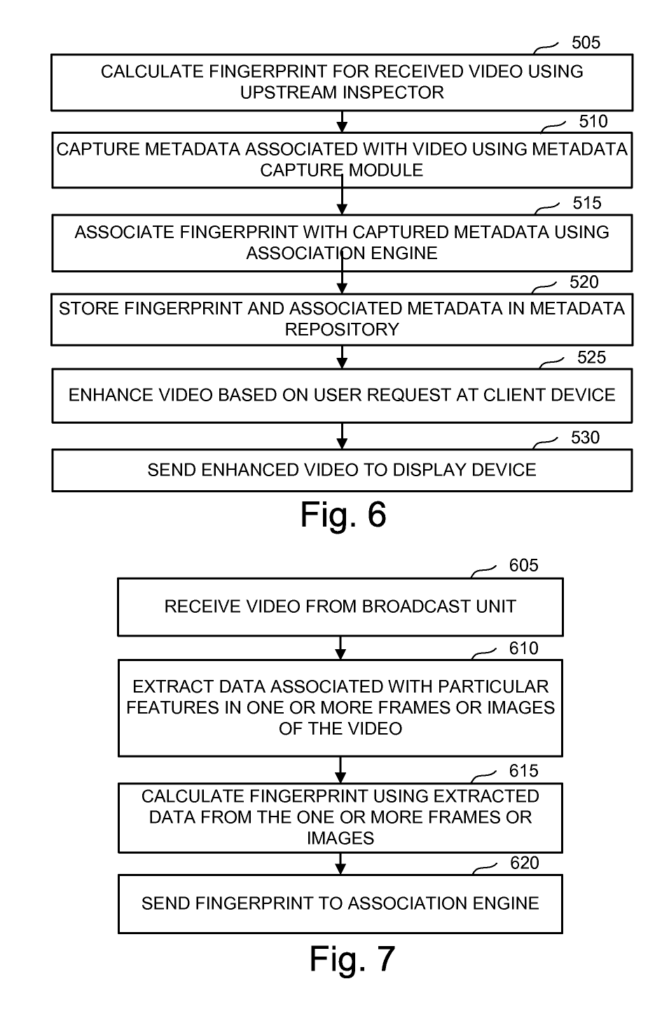

FIG. 6 is a flow chart for one process for enhancing video. In step 505, a fingerprint for video received from camera 105 or other cameras is calculated at the upstream inspector 120. In step 510, the metadata capture module captures metadata associated with the video from camera 105 and any other cameras. The association engine then associates the calculated fingerprints with metadata corresponding to the segment of video for which the fingerprint was calculated (step 515). The fingerprint with the associated metadata is stored in the metadata repository (step 520). Video received at the client device 140 can then be enhanced for a user using metadata from the metadata repository 130 (step 525). The enhanced video is then sent from the client device 140 to the display device 145 (step 530).

FIG. 7 is a flow chart for one process of calculating a fingerprint for received video at the upstream inspector 120 (step 505 of FIG. 6). In step 605, video is received at the upstream inspector 120 from the broadcast unit 110. The upstream inspector 120 then extracts data from particular features in a segment of received video based on the fingerprint algorithm used (step 610). The extracted data is then used to calculate a fingerprint for the segment of video using the fingerprint algorithm that the upstream inspector 120 is programmed to use (step 615). The fingerprint is then sent to the association engine 125 (step 620).

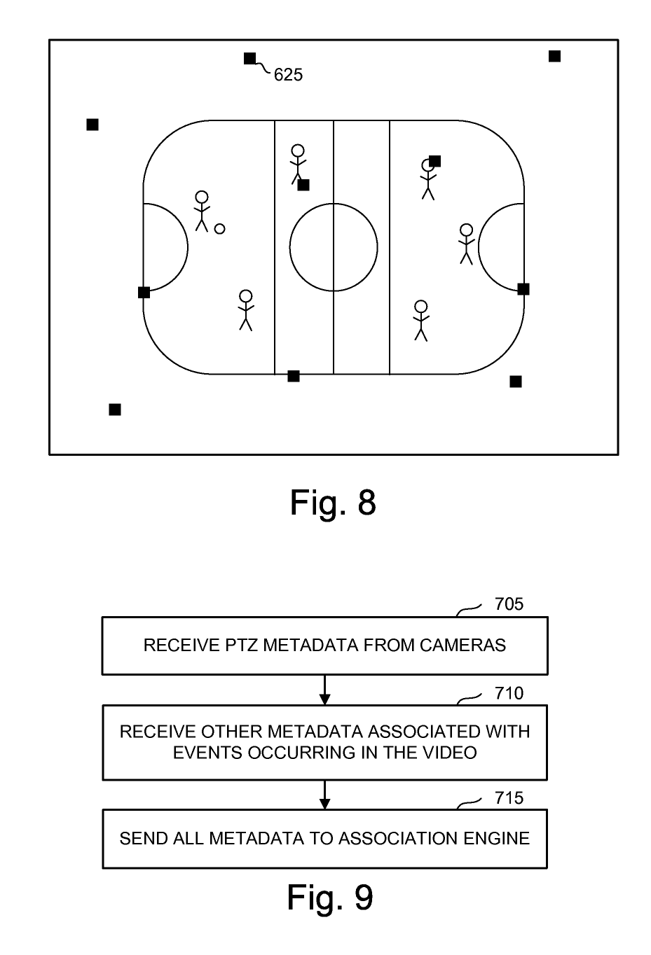

FIG. 8 shows one example of the process described in FIG. 7. FIG. 8 depicts an image for a segment of video. In this example, for simplicity purposes, the segment of video is one frame or image of video. The black squares 625 indicate the particular features that may be used in the fingerprint algorithm. The black squares 625 may be pixels or sets of pixels, for example. The data associated with the black squares 625 are extracted by the fingerprint extractor 215 of the upstream inspector 120. The extracted data from the particular features (black squares 625) are used to calculate a fingerprint for that frame or image of video.

FIG. 9 is a flow chart for one process of capturing metadata associated with video using the metadata capture module 115 (step 510 of FIG. 6). In step 705, the metadata capture module 115 receives PTZ metadata from camera 105 and any other cameras. The metadata capture module 115 also receives other metadata associated with events occurring in the video (step 710). In one embodiment, the metadata can be received via an operator keeping track of the data about events occurring in the video. The PTZ metadata as well as any other metadata captured by the metadata capture module 115 will then be sent to the association engine 120 (step 715).

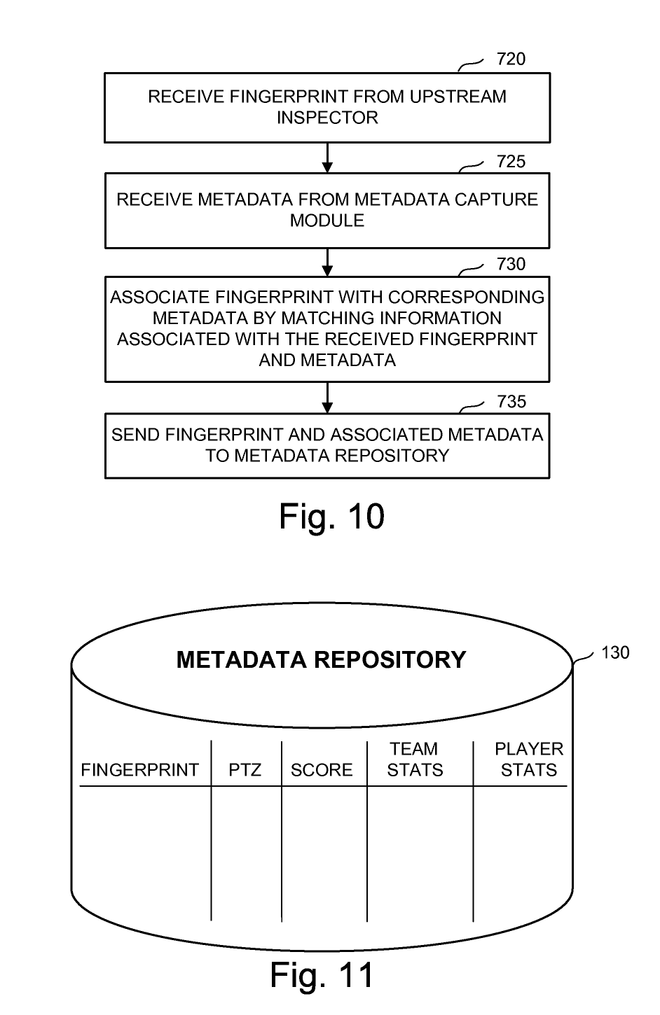

FIG. 10 is a flow chart for one process of associating the fingerprint received from the upstream inspector 120 with the metadata captured at the metadata capture module 115 using the association engine 125 (step 515 of FIG. 6). In step 720, the association engine 125 receives the fingerprint from the upstream inspector 120. The association engine 125 also receives metadata from the metadata capture module 115 (step 725). The association engine 125 then associates the fingerprint with corresponding metadata by matching information associated with the received fingerprint and metadata (step 730). The information associated with the received fingerprint and metadata can be a time associated with both. In one embodiment, the metadata capture module 115 and the upstream inspector 120 can be synchronized so that the metadata and the fingerprint associated with a segment of video arrive at the association engine 125 at the same time so that they can be accurately associated. The associated fingerprint and metadata are then sent to the metadata repository 130 (step 735).

FIG. 11 depicts one example of a metadata repository 130 for storing metadata and the associated fingerprints (step 520 of FIG. 6). In FIG. 11, the metadata is indexed by fingerprints. This allows the downstream inspector 425 in the client device 140 to quickly access the metadata using the fingerprint calculated at the downstream inspector 425. In another embodiment, the metadata can be indexed in consecutive frame or image order. However, the metadata repository 130 is not limited to those types of organization techniques. In FIG. 11, the metadata associated with the fingerprints can be PTZ metadata, a score associated with the segment of video, team statistics, player statistics for players in the segment of video. However, the metadata can be any type of data associated with the segment of video.

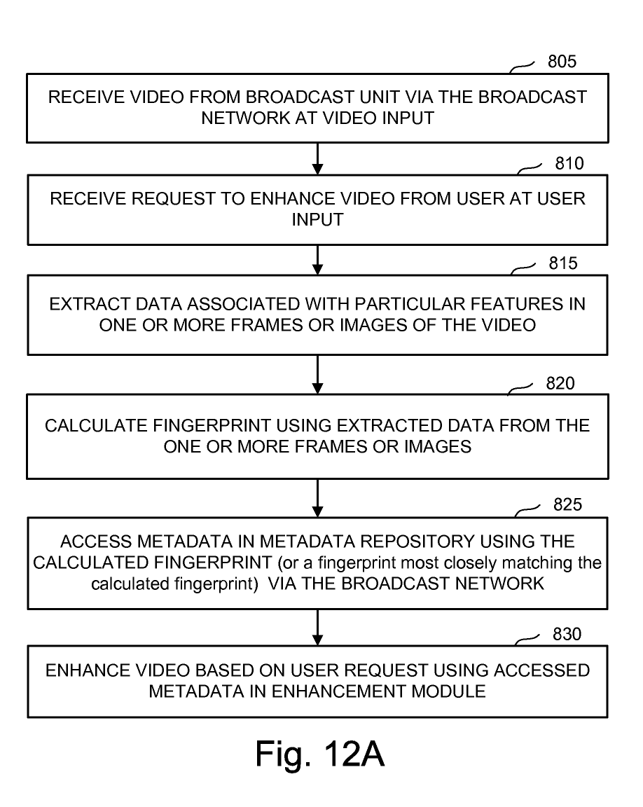

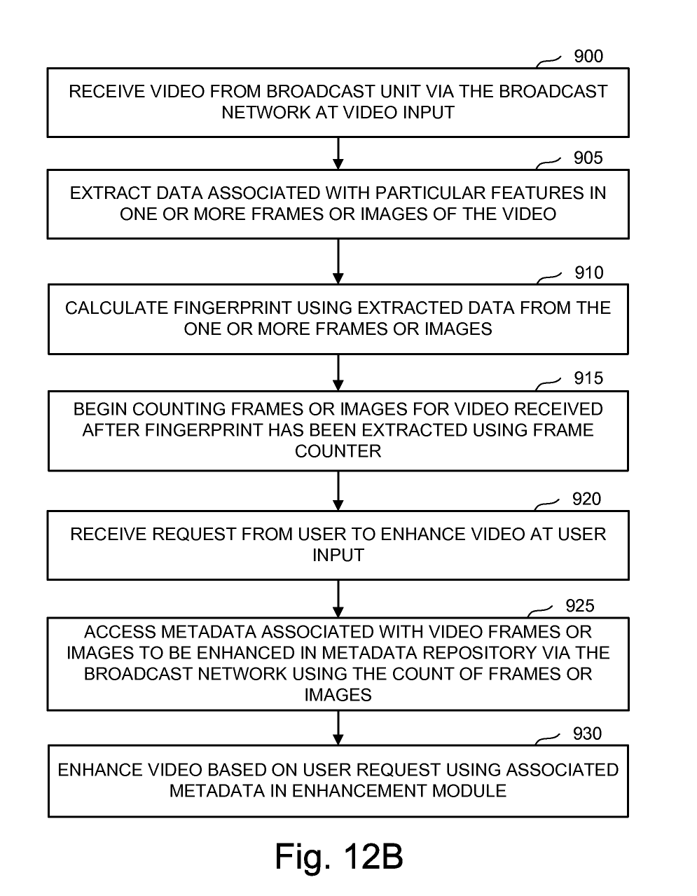

FIG. 12A is a flow chart for one process of enhancing video at a client device 140 based on a user request (step 525 of FIG. 6). In step 805, the client device 140 receives video from the broadcast unit 110 via the broadcast network 135 at the video input 405 of the client device 140. A user request to enhance the video is received from the user at the user input 410 of the client device 140 (step 810). When the user request to enhance video is received, the downstream inspector 425 will extract data associated with particular features in the segments of video that should be enhanced based on the fingerprinting algorithm used at the downstream inspector 425 (step 815). The fingerprint algorithm used at the downstream inspector 425 yields results similar to the algorithm used at the upstream inspector 120. The downstream inspector 425 will then calculate fingerprints for segments of video that should be enhanced using the extracted data (step 820). The fingerprints are calculated using a similar fingerprint algorithm as that used by the upstream inspector 120. The calculated fingerprints will be used by the downstream inspector 425 to access metadata in the metadata repository 130 via the broadcast network (step 825).

Additionally, the downstream inspector 425 may access metadata for a fingerprint closely matching the calculated fingerprint. As described earlier, a fingerprint calculated for a segment of video at the upstream inspector 120 may differ slightly from a fingerprint calculated for the same segment of video at the downstream inspector 425. The downstream inspector 425 may calculate fingerprints for several segments of video and use that set of fingerprints to access associated metadata from the metadata repository 130. Even if some of the fingerprints do not precisely match the fingerprints associated with the metadata in the metadata repository 130, the downstream inspector 425 will be able to determine which metadata is associated with the segments of video for which the fingerprints were calculated by roughly matching the set of fingerprints with those stored in the metadata repository 130. In this case, the metadata should be accessed in order of consecutive segments of video in the metadata repository 130.

Once the metadata for video is accessed, the video can be enhanced based on the user request using the enhancement module 435 (step 830). For example, if the user requested that a score be displayed, the enhancement module 435 may insert a graphic that displays the score of a game for each segment of video that should be enhanced.

FIG. 12B is a flow chart for another process of enhancing video at a client device 140 based on a user request (step 525 of FIG. 6). In step 900, the video input 405 receives video from the broadcast unit 110 via the broadcast network 135. The downstream inspector 425 extracts data associated with particular features in a segment of video received (step 905). The downstream inspector uses the same or about the same particular features as those used in the upstream inspector 120. In one embodiment, the segment of video for which the data is extracted is one of the first segments of video received at the client device 140. After the data for that segment of video has been extracted by the downstream inspector 425, the downstream inspector 425 calculates a fingerprint for the segment of video using the extracted data (step 910). The fingerprint is calculated using a fingerprint algorithm which yields results similar to the fingerprint algorithm used by the upstream inspector 120. The frame counter 430 in the client device 140 begins counting frames or images for video received subsequent to the segment of video for which a fingerprint was calculated (step 915).

In step 920, a request to enhance video is received from a user at the user input 410 of the client device 140. The downstream inspector 425 will access metadata stored in the metadata repository 130 via the broadcast network 135 using the count of frames or images (step 925). The downstream inspector 425 may access metadata for a particular frame or image using the count for that frame or image relative to the segment of video for which a fingerprint was calculated. The downstream inspector 425 will locate metadata for the segment of video using the calculated fingerprint and retrieve data for the particular frame or image by accessing the metadata for the number of frames or images after the segment of video for which the fingerprint was calculated using the count of frames or images. Once the metadata is accessed, the enhancement module 435 will enhance the video using the accessed metadata based on the request from the user (step 930).

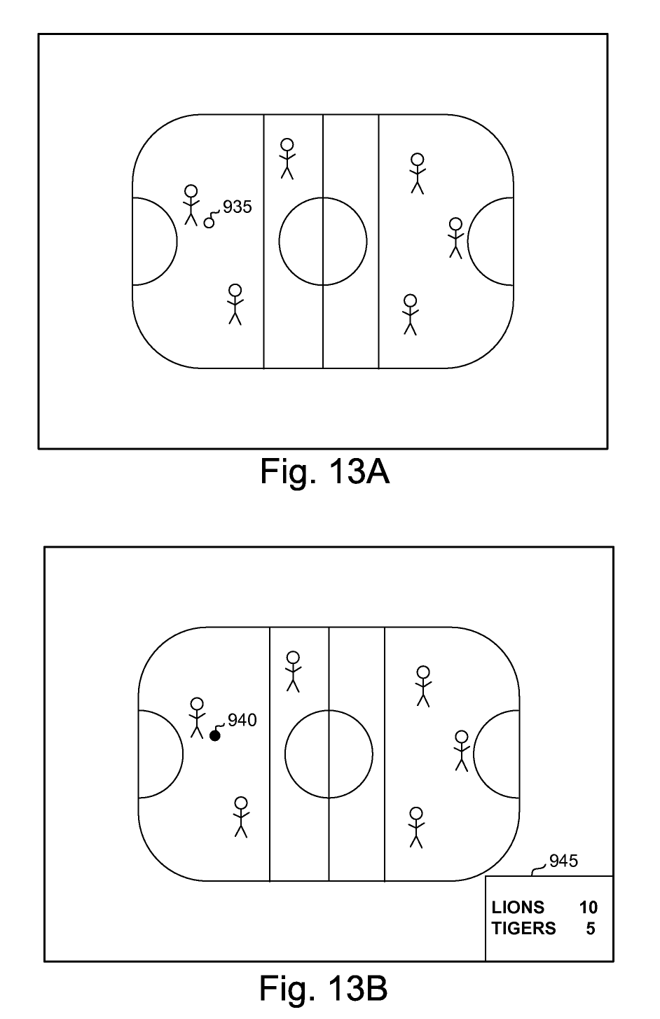

FIG. 13A depicts one example of a segment of video before it is enhanced. The example depicts a soccer game. In FIG. 13A, the soccer ball 935 is not enhanced. If a user requested that a score be displayed and the soccer ball 935 be enhanced, the client device 140 will perform the process of enhancement as described in FIG. 12A and FIG. 12B. However, the client device 140 is not limited to only those processes for enhancement.

FIG. 13B depicts one example of what the segment of video shown in FIG. 13A would look like after the client device 140 enhances the video based on the user request. The soccer ball 940 is enhanced by inserting a graphic over the soccer ball so that it is more visible to the user. This may be done by accessing the metadata associated with the position of the soccer ball 140 within the segment of video and inserting a graphic at that position. Additionally, the client device 140 accesses the metadata associated with the score for the segment of video and inserts a graphic that indicates the score 945.

The foregoing detailed description of the invention has been presented for purposes of illustration and description. It is not intended to be exhaustive or to limit the invention to the precise form disclosed. Many modifications and variations are possible in light of the above teaching. The described embodiments were chosen in order to best explain the principles of the invention and its practical application, to thereby enable others skilled in the art to best utilize the invention in various embodiments and with various modifications as are suited to the particular use contemplated. It is intended that the scope of the invention be defined by the claims appended hereto.

We claim:

1. A method for enhancing video, comprising:
receiving video at a client device;
calculating a first identifier of one or more images of said video at said client device using particular features within said one or more images;
accessing metadata associated with said one or more images using said first identifier; and
enhancing said one or more images using said metadata.

2. A method according to claim 1, further comprising:
receiving a request to enhance said one or more images of said video from a user, said step of enhancing is based on said request.

3. A method according to claim 1, further comprising:
sending said one or more images of said video to a display device.

4. A method according to claim 1, wherein said step of enhancing comprises:
inserting a graphic into a display of said one or more images using said metadata.

5. A method according to claim 1, wherein:
said metadata is data indicating a camera position, camera orientation, or intrinsic parameters associated with said one or more images of said video.

6. A method according to claim 1, wherein:
said metadata is data associated with events occurring in said one or more images of said video.

7. A method according to claim 1, further comprising:
counting images of said video received after said one or more images; and
accessing metadata associated with said images of said video using a count of said images received at said client device.

8. A method according to claim 1, wherein said step of calculating a first identifier comprises:
extracting said particular features from said one or more images; and
calculating said first identifier using said particular features in an identifier function.

9. A method according to claim 1, wherein:
said step of calculating includes calculating subsequent identifiers for images of video received after said one or more images; and
said step of accessing includes accessing metadata for said video using said first identifier and said subsequent identifiers.

10. A method according to claim 1, wherein:
said particular features are associated with data about particular pixels in said one or more images of said video.

11. A system for enhancing video, further comprising:
upstream inspection circuitry, said upstream inspection circuitry receives video and calculates an identifier of one or more images of said video using particular features within said one or more images;
association circuitry, said association circuitry associates said identifier with metadata of said one or more images;
downstream inspection circuitry, said downstream inspection circuitry receives said video and calculates said identifier of said one or more images using said particular features, said downstream inspection circuitry accesses said metadata using said identifier; and
enhancement circuitry, said enhancement circuitry enhances said one or more images using said metadata.

12. A system according to claim 11, wherein:
said upstream inspection circuitry extracts data associated with said particular features within said one or more images and calculates said identifier using said data.

13. A system according to claim 11, further comprising:
user input circuitry, said user input circuitry receives a request to enhance said one or more images of said video, said enhancement circuitry enhances said video based on said request.

14. A system according to claim 13, wherein:
said user input circuitry receives a request to enhance said video, said downstream inspection circuitry accesses metadata for images of said video using a count of images of said video, said enhancement circuitry enhances said video based on said request.

15. A system according to claim 11, further comprising:
image counter circuitry, said image counter circuitry counts images of said video received at said downstream inspection circuitry after said downstream inspection circuitry calculates said identifier.

16. An apparatus for enhancing video, comprising:
video input circuitry, said video input circuitry receives video;
downstream inspection circuitry, said downstream inspection circuitry calculates an identifier of one or more frames of said video using particular features within said one or more frames, said downstream inspection circuitry accesses metadata associated with said one or more frames using said identifier; and
enhancement circuitry, said enhancement circuitry enhances said one or more frames using said metadata.

17. A system according to claim 16, further comprising:
user input circuitry, said user input circuitry receives a request to enhance said one or more frames of said video, said enhancement circuitry enhances said one or more frames based on said request.

18. A system according to claim 17, further comprising:
video output circuitry, said video output circuitry sends said video to a display device based on said request to enhance.

19. A system according to claim 16, further comprising:
frame counter circuitry, said frame counter circuitry counts frames of said video received at said downstream inspection circuitry after said downstream inspection circuitry calculates said identifier.

20. A system for enhancing video, comprising:
a first set of one or more processors, said first set of one or more processors receives video and calculates an identifier of one or more frames of said video using particular features within said one or more frames;
a second set of one or more processors in communication with said first set of one or more processors, said second set of one or more processors associates said identifier with metadata of said one or more frames; and
a client device, said client device receives said video and calculates said identifier of said one or more frames using said particular features, said client device accesses said metadata using said identifier, said client device enhances said one or more frames using said metadata.
